(19) United States
(12) Patent Application Publication
(10) Pub. No.: US 2012/0102882 A1
(43) Pub. Date: May 3, 2012

(54) TRAY SEALER AND METHOD OF OPERATING THE SAME

(75) Inventors: Elmar Ehrmann, Bad Groenenbach (DE); Bernd Jokele, Kempten (DE); Tieme Jan Slomp, Bad Groenenbach (DE); Stefan Scheibel, Memmingen (DE)

(73) Assignee: MULTIVAC SEPP HAGGENMUELLER GMBH & CO. KG, Wolfertschwenden (DE)

(21) Appl. No.: 13/281,932

(22) Filed: Oct. 26, 2011

(30) Foreign Application Priority Data
Oct. 26, 2010 (DE) 10 2010 049 588.3

(51) Int. Cl. B65B 31/00; B65G 37/00

(52) U.S. Cl. 53/403; 414/564; 414/800; 53/79

(57) ABSTRACT

The disclosure relates to a tray sealer comprising a tray conveyor, the conveyor being provided with tray reception means each configured for receiving a tray therein. The disclosure is characterized in that the tray sealer comprises, at a loading station, a loading robot for placing trays filled with a product into tray reception means and, at an unloading station, an unloading robot for removing trays which have been sealed by means of the tray sealer from the tray reception means. The disclosure also relates to a method of operating a tray sealer operable in intermittent operation cycles.

### CROSS-REFERENCE TO RELATED APPLICATIONS

This application claims foreign priority benefit under 35 U.S.C. §119(a)-(d) to German patent application number DE 102010049588.3, filed Oct. 26, 2010 which is incorporated by reference in its entirety.

### TECHNICAL FIELD

The disclosure relates to a tray sealer as well as to a method of operating a tray sealer used for sealing trays and operable in intermittent operation cycles.

### BACKGROUND

Such tray sealers are widely used in the packaging industry. The most widely used type of such tray sealers, which is described e.g. in DE 10 2004 023 473 A1, comprises one or a plurality of conveyor belts onto which the trays are placed and on which the trays are conveyed into a sealing station and out of said sealing station. In the case of a second, less widely used type of tray sealers, the machines comprise a tray conveyor provided with tray reception means. Such a tray sealer is disclosed in EP 1 038 773 B1 or in DE 10 2004 011 311 A1. A completely different kind of packaging system, which is not implemented for closing trays but for inserting cosmetic bottles into cartons, is disclosed in DE 20 2005 015 247 U1.

### SUMMARY

It is the object of the present disclosure to provide a tray sealer and a method of operating the same, which are improved with respect to more flexible possibilities of use.

The tray sealer according to the present disclosure is characterized in that it comprises, at a loading station, a loading robot for placing trays filled with a product into tray reception means and, at an unloading station, an unloading robot for removing the sealed trays. The robots guarantee that the trays can be fed very rapidly to the tray sealer, and that the sealed trays can be removed very rapidly from the tray sealer. The speed with which the two robots are able to insert the trays into the tray reception means or remove them from said tray reception means is much higher than in cases where these processes are carried out by hand.

According to the present disclosure, the loading and unloading speed is increased still further in that the tray reception means establish defined positions for the trays on the tray conveyor. Therefore, the two robots need no longer recognize where a tray is to be inserted or removed, but they can be adapted directly to the positions of the tray reception means which are already known in advance. Complicated calculating steps can therefore be dispensed with, so that the robots can execute their processes within a shorter period of time. This, in turn, has the effect that the loading station and the unloading station can have a very short overall length so that also the structural design of the tray sealer in its entirety can be very compact. A conveyor by means of which filled trays are provided can lead to the loading station at any desired angle—also at an angle of 90°.

The tray sealer can normally be operated in an intermittent mode, i.e. in successive operation cycles. In each operation cycle, the trays are advanced by a specific conveying distance. According to an advantageous variant of the disclosure, the distance from the unloading station to the loading station is two to five times as large as this conveying distance; preferably it is only two or three times as large as said conveying distance. The tray sealer is rendered very short in this way. In a first operation cycle, the trays can be inserted in the tray reception means, in a subsequent operation cycle they can be sealed in a sealing station, and in a further operation cycle the trays can be removed by means of the unloading robot. Since the trays are subjected to an operating step in (almost) every operation cycle, a shorter overall length of the tray sealer will hardly be possible. This compact structural design of the tray sealer according to the disclosure allows the use of said tray sealer also in narrow premises.

Preferably, the tray conveyor is an endless conveyor, since this will support a smooth operation of the tray sealer. For example, the tray conveyor may comprise a plurality of crossbars which extend transversely to the conveying direction between two endless conveyor chains. A respective tray reception means may be formed between certain crossbars.

According to another variant, the tray conveyor is a plate chain comprising a plurality of plates and tray reception means formed between said plates. The plate chain has the advantage that it is very stable. In addition, the plates guarantee a distance between neighboring trays in the conveying direction.

The tray conveyor may comprise a frame member which, in turn, comprises one or a plurality of tray reception means. When such a frame member is provided on a plate chain, it may be provided between two plates and, in turn, define the tray reception means and the shape of the latter. The frame member may, however, also be provided independently of an endless conveyor, e.g. in the form of a firm, horizontal frame member defining one or a plurality of tray reception means.

Especially in the case of the last-mentioned embodiment it would be imaginable to provide a horizontal return facility for returning a frame member from the unloading station to the loading station. In this variant, a plurality of frame members, e.g. three, four or five frame members may be provided, which are conveyed in a horizontal direction from the loading station to the unloading station and, by means of the return facility, from the unloading station back to the loading station.

It will be expedient when the loading robot and/or the unloading robot is/are configured for conveying a plurality of trays. Loading and unloading of the tray sealer can be accelerated in this way.

The disclosure also relates to a method of operating a tray sealer used for sealing trays and operable in intermittent operation cycles. According to this method, trays to be sealed are placed, at a loading station, into tray reception means of a tray conveyor by means of a loading robot. In order to reduce the dwell time of the trays in the tray sealer, the trays have already been filled with a product prior to their insertion in the tray reception means. At an unloading station, the trays are then removed by means of an unloading robot.

According to an advantageous variant of said method, the trays are conveyed from the loading station to the unloading station in a maximum of four operation cycles of the tray sealer, preferably in even only two or three operation cycles. This has, on the one hand, the effect that the dwell time of the products in the tray sealer will be rendered very short, and, e.g. in the case of cooled products, this may prevent an increase in temperature and may thus be advantageous. On the other hand, the tray sealer will be rendered very compact in this way.

It would be imaginable that, in a sealing station located between the loading station and the unloading station, the trays are evacuated, flushed with a substitute gas or a substitute gas mixture, and closed and/or sealed with a top film. Although the trays dwell in the tray sealer for only a small number of operation cycles, it is nevertheless possible to subject them to many operating steps.

In the following, advantageous embodiments of the tray sealer according to the present disclosure and of the method according to the present disclosure will be explained in more detail with reference to the below drawings.

### BRIEF DESCRIPTION OF THE DRAWINGS

FIG. 1 is a schematic view of a first embodiment of a tray sealer according to the present disclosure; and

FIGS. 2-7 illustrate various operating steps executed during operation of a second embodiment of a tray sealer.

### DETAILED DESCRIPTION

Corresponding components are designated by identical reference numerals throughout the figures.

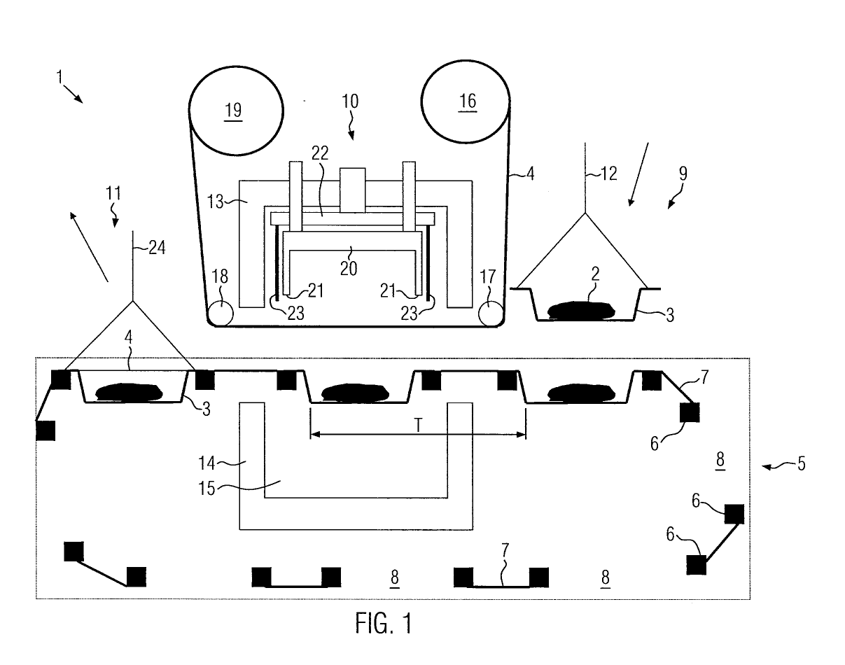

FIG. 1 shows in a schematic representation a first embodiment of a tray sealer 1 according to the present disclosure. In said tray sealer 1, trays 3 filled with a product can be closed by means of a top film 4.

The tray sealer 1 is provided with a tray conveyor 5 by means of which the trays 3 are conveyed in the tray sealer 1. In the present embodiment the tray conveyor 5 is a continuously circulating conveyor means, in particular a plate chain. This plate chain 5 comprises a plurality of chain links 6. Two respective neighboring chain links 6 have provided between them either a rigid plate 7 or a tray reception means 8 in alternate succession. The chain links 6 need not be distributed equidistantly in the plate chain 5. It would e.g. be imaginable that two chain links 6 interconnected by a plate 7 are spaced more closely than two neighboring chain links 6 having a tray reception means 8 disposed between them.

The tray sealer 1 additionally comprises a loading station 9, a sealing station 10, which may have integrated therein a cutting station for cutting the top film 4, and an unloading station 11. At the loading station 9 a loading robot 12 is provided. It is equipped with a gripping tool by means of which it is able to grip one or a plurality of trays 3 simultaneously, said trays 3 being provided e.g. on a conveyor belt or a conveyor surface (not shown). By means of a suitable controller, the loading robot 12 is programmed such that it will feed the trays 3 into the tray reception means 8 of the tray conveyor 5 at the loading station 9.

The sealing station 10 comprises an upper die 13 and a lower die 14, which are adapted to be moved relative to one another, so that they can close around one or a plurality of trays 3, in particular in a gas-tight fashion. A chamber 15 formed between the upper die 13 and the lower die 14 is evacuable and/or fillable with a substitute gas or a substitute gas mixture. The dimensions of the upper and lower dies 13, 14 are chosen such that the respective outer walls of the two die members 13, 14 meet in the area of a plate 7 of the plate chain 5.

The top film 4 is a sealable plastic film. It is unwound from a film roll 16 and deflected by means of a deflection pulley 17 such that it passes substantially horizontally between the upper die 13 and the lower die 14. The first deflection pulley 17 is arranged directly outside of the upper die 13, in particular between the loading station 9 and the sealing station 10.

A second deflection pulley 18 on the output side of the sealing station 10 directs the residual film grid of the top film 4, which remains when the trays 3 have been closed, to a residual film winder 19. Also the second deflection pulley 18 is arranged directly outside of the dies 13, 14 of the sealing station 10 so as to remove the residual film grid 4 from the sealed trays 3 as soon as possible after the sealing station 10.

The upper die 13 of the sealing station 10 has provided therein a heatable sealing tool 20. Sealing edges 21 of the sealing tool 20 can seal the top film 4 onto the trays 3 by transferring heat and by applying, where appropriate, a sealing pressure at the same time. The sealing tool 20 may be movable relative to the upper die 13 so as to first allow, when the upper and lower dies 13, 14 have been closed, an evacuation of the trays 3 and/or gas flushing of the trays 3 before the trays 3 are subsequently closed and sealed.

The upper die 13 has additionally provided therein a cutting tool 22. This cutting tool 22 is movable relative to the upper die 13 and the sealing tool 20 and it is equipped with cutting knives or cutting edges 23 which cut through the top film 4 in the area of the edges of the trays 3 and which are thus able to separate the packages from one another.

An unloading robot 24, whose structural design can correspond to that of the loading robot 12, is provided at the unloading station 11. This unloading robot 24 may e.g. be a scara robot or a delta robot. The unloading robot 24 serves to remove the trays 3, which have been closed with the top film 4, from the tray sealer 1.

The operation of the tray sealer 1 and the method according to the present disclosure, respectively, take place as follows hereinbelow.

Trays 3, which have already been filled with a product 2, are provided on a conveyor surface or a conveyor belt. The loading robot 12 grips, by means of a gripping tool, one or a plurality of trays 3, moves the tray (or the trays) 3 to tray reception means 8, while the tray conveyor 5 is standing still, and places a respective tray 3 into a tray reception means 8. In this way, either one tray 3 or, simultaneously or sequentially, also several trays 3 can be fed into tray reception means 8 of the tray conveyor 5 while said tray conveyor 5 is standing still. In a conveying interval of the operation cycle of the tray sealer 1, the tray conveyor 5 is then advanced by a conveying distance T. The trays 3 that have been inserted in the tray reception means 8 at the loading station 9 arrive in this way at the sealing station 10.

In the sealing station 10, the upper and lower dies 13, 14 are closed around the trays 3 so as to form a chamber 15 which is sealed in a gas-tight fashion. This chamber 15 is evacuated and, where appropriate, flushed with a substitute gas or a substitute gas mixture. Immediately after the evacuation and/or gas flushing, the sealing tool 20 is lowered onto the top film 4 so as to press the latter onto the edges of the trays 3 with a sealing pressure. Simultaneously, heat is transferred from the sealing tool 20 to the top film 4 for sealing said top film 4 onto the trays 3. Subsequently, the cutting tool 22 is lowered so as to cut through the top film 4 by means of the cutting edges 23.

As soon as the upper and lower dies 13, 14 have been opened again, the residual film grid of the top film 4 is advanced to the residual film winder 19. Simultaneously, the tray conveyor 5 is driven so as to move the trays 3 by a conveying distance T once more. In this way, the trays 3 arrive at the unloading station 11, where they are removed by means of the unloading robot 24.

In the embodiment shown in FIG. 1, the distance between the unloading station 11 and the loading station 9 is only twice as large as the conveying distance T of a single operation cycle of the packaging machine 1. Therefore, the upper run of the tray conveyor 5 never comprises more than three successive tray reception means 8 at a time. A tray sealer 1 having a very compact structural design in the conveying direction is obtained in this way. Another advantage is to be seen in the fact that the plate chain used as tray conveyor 5 is rendered very short. In the embodiment according to FIG. 1, said plate chain only comprises eight tray reception means 8 and eight plates 7, respectively, along its longitudinal direction. Since the plate chain 5 is very short, it can be removed comparatively easily and exchanged e.g. for a change of format of the trays 3.

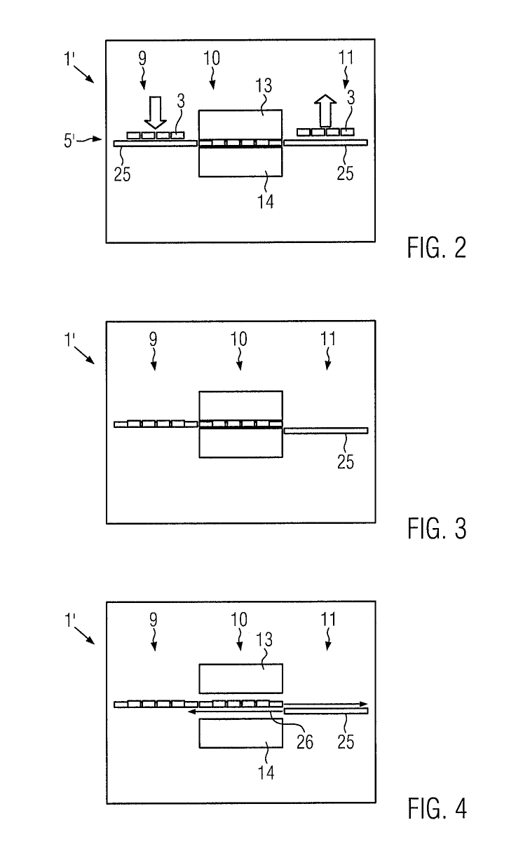

FIGS. 2 to 7 show a second embodiment of a tray sealer 1′ according to the present disclosure in different operating states. For the sake of clarity, only the essential components of this tray sealer 1′ are shown in a schematic representation. Other than the first embodiment, the tray sealer 1′ is not provided with a continuously circulating tray conveyor 5. Instead, a group of (in the present embodiment: three) frame members 25 is provided as tray conveyor 5′. Each frame member 25 comprises a plurality of tray reception means 8 which are adapted to have trays 3 inserted therein. The frame members 25 of the tray conveyor 5′ are adapted to be conveyed through the tray sealer 1′ in a horizontal direction.

FIG. 2 shows a state of the tray sealer 1′ in which a group of four trays 3 is inserted into a frame member 25 by means of a loading robot (not shown) at a loading station 9. Simultaneously, a second frame member 25, which also accommodates a group of four trays 3, is disposed between the closed dies 13, 14 of the sealing station 10 for closing the trays 3 there with a top film 4. At an unloading station 11, an unloading robot (not shown) removes sealed trays 3 from a third frame member 25. In FIG. 2, all three frame members 25 are disposed in the same conveying plane in which they are conveyed from the left to the right through the tray sealer 1′.

FIG. 3 shows the tray sealer 1′ a bit later on. The first group of trays 3 has been inserted into the tray reception means 8 of the frame member 25 at the loading station 9. The second group of trays 3 is still disposed in the sealing station, whereas the third group of trays 3 has left the unloading station 11 in the meantime. In addition, the frame member 25 has been lowered at the unloading station 11 from the conveying plane into a return plane below said conveying plane.

In FIG. 4 the upper and lower dies 13, 14 have moved away from one another so as to open the sealing station 10. Arrows indicate that the frame member 25 can now be conveyed from the sealing station 10 in the conveying plane to the right towards the unloading station 11. Simultaneously, the frame member 25, which is still disposed in the unloading station 11, can be returned in the return plane extending therebelow to the loading station 9 along a horizontal return facility 26, e.g. a rail.

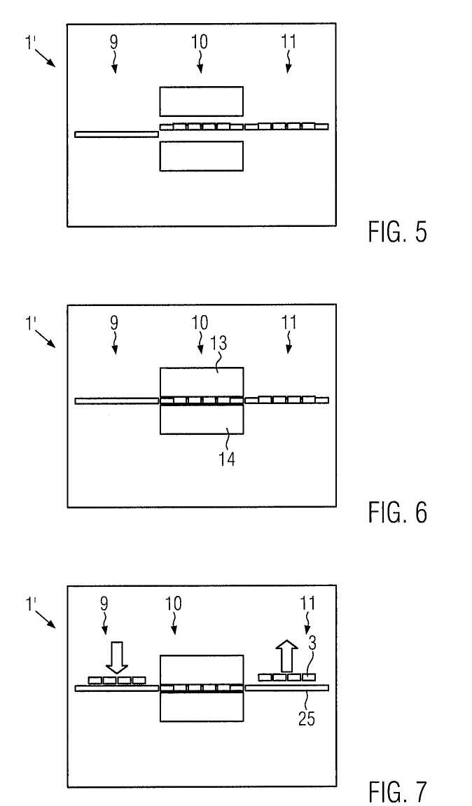

FIG. 5 shows the state in which the third frame member 25 has re-entered the loading station 9. The two other frame members 25, which are still disposed in the conveying plane, have been displaced to the right, each by one frame length.

In FIG. 6 the upper die 13 and the lower die 14 have been closed around the group of trays 3 disposed therebetween. The frame member 25 at the loading station 9 has been lifted from the return plane into the conveying plane so that it is now disposed in the same plane as the other two frame members 25.

In FIG. 7, at the loading station 9, new trays 3 are inserted into the frame member 25 disposed at said loading station 9, whereas in the sealing station 10 trays 3 are closed and at the unloading station 11 trays are removed from the frame member 25 disposed at said unloading station 11. The state according to FIG. 7 corresponds to the state according to FIG. 2, so that an operation cycle has been finished.

The two depicted embodiments of tray sealers 1, 1′ correspond to one another in particular insofar as at a loading station 9 as well as at an unloading station 11 a respective robot 12, 24 is provided for inserting filled trays 3 into tray reception means 8 and for removing sealed trays 3 from said tray reception means 8. The embodiments of the tray sealers 1, 1′ also correspond to one another insofar as the respective trays 3 only dwell in the tray sealer 1, 1′ for three operation cycles, i.e. a first operation cycle for inserting, a second operation cycle for closing and a third operation cycle for removing the trays 3.

Starting from the embodiments shown, the tray sealer 1, 1′ according to the present disclosure and the method according to the present disclosure can be modified in many respects. It would e.g. be imaginable that the trays 3 also dwell in the tray sealer 1 for a slightly higher number of operation cycles, so as to execute e.g. additional operating steps, such as attaching labels to the trays 3. In this case, a labeling station may be provided between the sealing station 10 and the unloading station 11.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tray sealer comprising:
a tray conveyor, the conveyor being provided with a tray reception means configured for receiving a tray therein;
a loading robot, at a loading station, for placing a tray filled with a product into the tray reception means; and
an unloading robot, at an unloading station, for removing a tray which has been sealed by means of the tray sealer from the tray reception means.

2. A tray sealer according to claim 1, wherein the distance from the unloading station to the loading station is two to five times as large as the conveying distance over which a tray can be conveyed within one operation cycle of the tray sealer.

3. A tray sealer according to claim 1, wherein the tray conveyor is an endless conveyor.

4. A tray sealer according to claim 1, wherein the tray conveyor is a plate chain which comprises plates and tray reception means formed between the plates.

5. A tray sealer according to claim 1, wherein the tray conveyor comprises at least one frame member with one or a plurality of tray reception means.

6. A tray sealer according to claim 1, further comprising a horizontal return facility for returning a frame member from the unloading station to the loading station.

7. A tray sealer according to claim 1, wherein the loading robot and the unloading robot are configured for conveying a plurality of trays.

8. A method of operating a tray sealer used for sealing trays and operable in intermittent operation cycles, the method comprising:
placing trays filled with a product, at a loading station, into tray reception means of a tray conveyor by means of a loading robot; and
removing, at an unloading station, the trays from the tray reception means by means of an unloading robot after having been sealed previously.

9. A method according to claim 8, wherein the trays are conveyed from the loading station to the unloading station in a maximum of four operation cycles of the tray sealer.

10. A method according to claim 8, wherein, in a sealing station located between the loading station and the unloading station, the trays are evacuated, flushed with gas, closed with a top film, sealed and/or and separated from one another by cutting said top film.

11. A tray sealer comprising:
a tray conveyor having a tray reception compartment for receiving a tray therein;
a loading robot, at a loading station, for placing a tray filled with a product into the tray reception compartment;
a tray sealing station for sealing a tray in the tray reception compartment; and
an unloading robot, at an unloading station, for removing a tray which has been sealed by the tray sealer station from the tray reception compartment, the tray sealing station being disposed between the loading station and the unloading station.

12. A tray sealer according to claim 11, wherein the distance from the unloading station to the loading station is two to five times as large as the conveying distance over which a tray can be conveyed within one operation cycle of the tray sealer.

13. A tray sealer according to claim 11, wherein the tray conveyor is an endless conveyor.

14. A tray sealer according to claim 11, wherein the tray conveyor is a plate chain which comprises plates and tray reception compartments formed between the plates.

15. A tray sealer according to claim 11, wherein the tray conveyor comprises at least one frame member with one or a plurality of tray reception compartments.

16. A tray sealer according to claim 11, wherein the tray conveyor comprises at least one frame member with a plurality of tray reception compartments.

17. A tray sealer according to claim 15, further comprising a horizontal return facility for returning the at least one frame member from the unloading station to the loading station.

18. A tray sealer according to claim 11, wherein the loading robot and the unloading robot are configured for conveying a plurality of trays.
